(19) United States
(12) Patent Application Publication
(10) Pub. No.: US 2006/0066630 A1
(43) Pub. Date: Mar. 30, 2006

(54) Apparatus and method for transmitting data between graphics controller and external storage

(76) Inventors: Barinder Singh Rai, Surrey (CA); George Lyons, Langley (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/949,531

(22) Filed: Sep. 24, 2004

(51) Int. Cl. G09G 5/00; G06F 12/00; G09G 5/36

(52) U.S. Cl. 345/619; 345/559; 345/564

(57) ABSTRACT

A graphics controller and associated method of operation is provided. The graphics controller includes a memory for receiving image data from an image producing source. The graphics controller also includes an image data wrapper module having circuitry that operates independent of a processor external to the graphics controller. The image data wrapper module is configured to read image data from the memory and package the image data with transmission protocol formatting for transmission from the graphics controller to a memory card that is external to the graphics controller. The graphics controller further includes a memory card interface configured to enable transmission of the image data, having been packaged by the image data wrapper module, from the graphics controller to the memory card.

### BACKGROUND OF THE INVENTION

1. Field of the Invention

The present invention relates generally to processing of digital image data.

2. Description of the Related Art

Some modern digital imaging devices provide a capability for storing digital image data on an external storage device such as a memory card. In such a digital imaging device, the external storage is configured to interface with a graphics controller onboard the digital imaging device. Also, the graphics controller is connected to a central processing unit (CPU) of the digital imaging device. In conventional digital imaging devices, the CPU is responsible for performing a majority of the operations associated with transfer of digital image data between the graphics controller and the external storage connected thereto.

In conventional digital imaging devices, the transfer of digital image data between the graphics controller and the external storage requires at least the following CPU operations: reading all digital image data to be transferred, generation of cyclic redundancy check (CRC) data for all digital image data to be transferred, and writing all digital image data to a destination. Therefore, the process of transferring digital image data between the graphics controller and the external storage, as implemented by conventional digital imaging devices, is quite CPU intensive.

While the CPU is occupied performing the transfer of digital image data between the graphics controller and the external storage, other processes that require CPU attention may be delayed. Also, reading and writing of the digital image data and associated CRC data by the CPU requires toggling of input/output (I/O) lines between the CPU and the graphics controller. Toggling of the I/O lines between the CPU and the graphics controller consumes power. Consequently, transfer of digital image data between the graphics controller and the external storage, as implemented by conventional digital imaging devices, can be costly in terms of CPU bandwidth and power consumption. These CPU bandwidth and power consumption costs can become significant in portable electronic devices, e.g., cell phones, where processing power and battery life are at premiums.

In view of the foregoing, a solution is needed to improve digital image data transfer between the graphics controller and the external storage such that the corresponding digital image device's available CPU bandwidth and power consumption are less adversely impacted.

### SUMMARY OF THE INVENTION

In one embodiment, a graphics controller is disclosed. The graphics controller includes a memory, an image data wrapper module, and a memory card interface. The memory is configured to receive image data from an image producing source. The image data wrapper module includes circuitry that operates independent of processing external to the graphics controller. The image data wrapper module is configured to read image data from the memory and package the image data with transmission protocol formatting for transmission from the graphics controller to a memory card that is external to the graphics controller. The memory card interface is configured to enable transmission of the image data, having been packaged by the image data wrapper module, from the graphics controller to the memory card.

In another embodiment, a method for transmitting digital image data from a graphics controller to an external storage is disclosed. The method includes determining a location on the external storage to which the digital image data can be written. The method also includes reading the digital image data from a memory of the graphics controller. Reading of the digital image data is performed without assistive processing by a central processing unit (CPU) of a host device that is external to the graphics controller. The method further includes packaging the digital image data with transmission protocol formatting for transmission from the graphics controller to the external storage. The packaging is performed without assistive processing by the CPU of the host device that is external to the graphics controller. Additionally, the method includes transmitting the digital image data from the graphics controller to the external storage. Transmission of the digital image data is performed without assistive processing by the CPU of the host device that is external to the graphics controller.

In another embodiment, an apparatus for transmitting digital image data from a graphics controller to an external storage is disclosed. The apparatus includes means for determining a location on the external storage to which the digital image data can be written. The apparatus also includes means for reading the digital image data from a memory of the graphics controller. The means for reading does not require assistive processing by a central processing unit (CPU) of a host device that is external to the graphics controller. The apparatus further includes means for packaging the digital image data with transmission protocol formatting for transmission from the graphics controller to the external storage. The means for packaging does not require assistive processing by the CPU of the host device that is external to the graphics controller. Additionally, the apparatus includes means for transmitting the digital image data from the graphics controller to the external storage. The means for transmitting does not require assistive processing by the CPU of the host device that is external to the graphics controller.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a digital image processing system, in accordance with one embodiment of the present invention;

FIG. 2 is an illustration showing the digital image processing system of FIG. 1 including an encoder/decoder (CODEC) for encoding and decoding the digital image data, in accordance with one embodiment of the present invention;

FIG. 3 is an illustration showing a flowchart of a method for transmitting digital image data from a graphics controller to an external storage, in accordance with one embodiment of the present invention; and

FIG. 4 is an illustration showing a flowchart of a method for transmitting data for an entire digital image from a graphics controller to a memory card, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

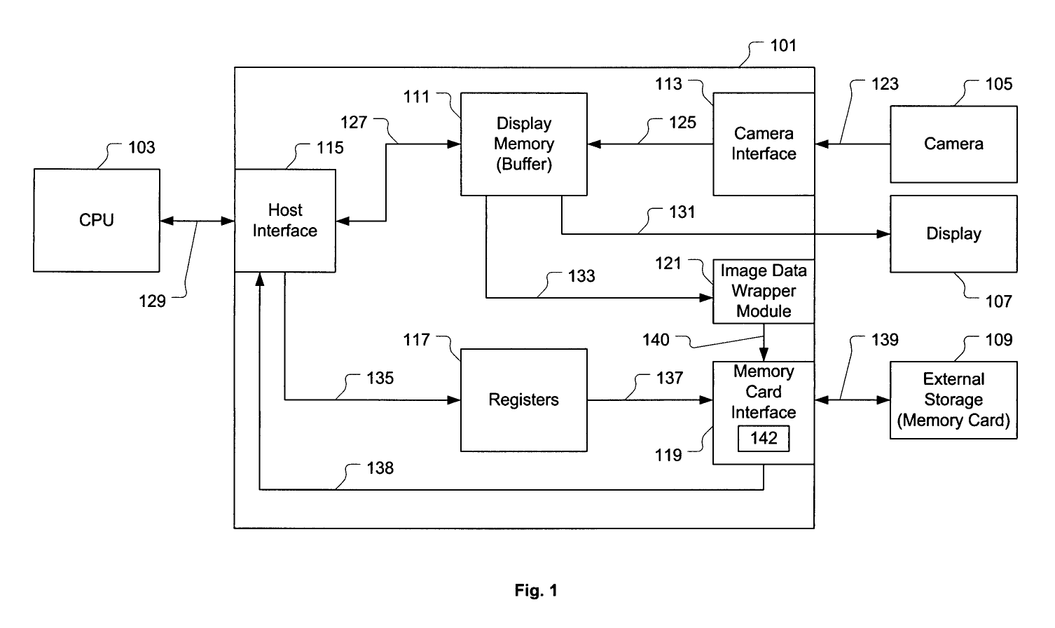

FIG. 1 is an illustration showing a digital image processing system, in accordance with one embodiment of the present invention. The various components and interconnections within the digital image processing system are described below, followed by an operational discussion of the digital image processing system.

The digital image processing system includes a camera 105, a graphics controller 101, a central processing unit (CPU) 103, and a display 107. It should be appreciated that the camera 105 can be a digital camera, a digital video camera, or any other device capable of capturing images in a digital format. Also, it should be appreciated that the display 107 can be any type of display device capable of rendering an image defined by electronic signals, e.g., a liquid crystal display (LCD), a plasma display, a cathode ray tube (CRT) display, etc. The CPU 103 represents a generalized host device CPU. It should be appreciated that the graphics controller 101 can be implemented in a host device to provide the host device with digital image processing capability.

The graphics controller 101 includes a camera interface 113, a display memory 111, a host interface 115, registers 117, a memory card interface 119, and an image data wrapper module 121. The camera interface 113 is configured to receive digital image data from the camera 105 as indicated by arrow 123. Digital image data from the camera 105 enters the camera interface 113 as a stream of bytes. In one embodiment, the digital image data arrives at the camera interface 113 in pixel order according to a raster sequence. The digital image data arriving at the camera interface 113 can represent streaming video from a digital video camera or a single snapshot from a digital camera. In the case of streaming video, each arriving frame of video can be considered as a single digital image, similar to the single snapshot arriving from the digital camera. For ease of discussion, the present invention is described in terms of receiving and processing data for a single digital image. However, it should be understood that the present invention can be implemented with both streaming video and snapshot images.

Image data received from the camera 105, through the camera interface 113, is stored in the display memory 111, i.e., video buffer, onboard the graphics controller 101, as indicated by arrow 125. From the display memory 111, the image data can be transmitted to the display 107 for visual rendering, as indicated by arrow 131. The image data can also be transmitted from the display memory 111 to either the host interface 115, as indicated by arrow 127, or the image data wrapper module 121, as indicated by arrow 133. The host interface enables two-way communication between the CPU 103 and the graphics controller 101, as indicated by arrow 129. Also, the CPU 103 is capable of reading data from and writing data to the display memory 111 via the host interface 115, as indicated by arrows 129 and 127.

The graphics controller 101 of the present invention is further configured to allow the registers 117 to be programmed by the CPU 103, via the host interface 115, as indicated by arrow 135. Additionally, the memory card interface 119 is capable of accessing and reading values stored in the registers 117, as indicated by arrow 137. The memory card interface is also configured to communicate information to the CPU 103, via the host interface, as indicated by arrow 138. The image data wrapper module 121 is defined to communicate with the memory card interface 119, as indicated by arrow 140. The memory card interface 119 enables communication between the graphics controller 101 and a memory card 109, as indicated by arrow 139. With respect to the present invention, the memory card 109 represents an external storage device capable of storing data, such as digital images. For discussion purposes, the memory card 109 is used as an exemplary embodiment of the external storage device. A few exemplary memory card 109 devices include the following: Secure Digital Card, Compaq Flash Card, Multi-Media Card, and Memory Stick. It should be appreciated, however, that the present invention is not limited to the aforementioned exemplary memory cards. The principles of the present invention can be applied in conjunction with essentially any type of external storage capable of storing digital image data.

The digital image processing system of FIG. 1, as described architecturally above, is further described below in operational terms associated with receiving a digital image from the camera 105 and storing the digital image on the memory card 109. As previously discussed, the camera 105 is capable of capturing a live image in a digital format. The live image having been captured and stored in the digital format is referred to as a digital image. The digital image is represented as a set of digital image data defining the various pixel values necessary to render the image in an electronic display. Upon capturing the digital image with the camera 105, the corresponding digital image data is transmitted to the camera interface 113 of the graphics controller 101. From the camera interface 113, the digital image data is transferred to the display memory 111. The digital image data is then maintained in the display memory 111 until further needed.

The graphics controller 101 of the present invention enables a user of the digital image processing system to store images maintained within the display memory 111 of the graphics controller 101 on the memory card 109. A sequence of operations necessary to store a digital image maintained in the display memory 111 on the memory card 109 will now be discussed. To begin the sequence of operations, the memory card interface 119 is initialized such that communication between the graphics controller 101 and the memory card 109 can occur.

Once the memory card interface 119 is initialized, a file system table for the memory card 109 is read from the memory card 109 by the CPU 103. It should be appreciated that the CPU 103 is capable of accessing information, such as the file system table, from the memory card 109 through the memory card interface 119 and the host interface 115, as indicated by arrows 129, 138, and 139. The file system table of the memory card 109 provides information regarding a current state of the memory card 109, including addresses, i.e., locations, where data is presently stored and addresses available to receive data for storage. In various embodiments, the file system table can take many different forms. For example, in exemplary embodiments, the file system table can comply with either the FAT16 or FAT32 format. It should be appreciated, however, that the present invention can be implemented with essentially any type of memory card 109 file system. More specifically, since reading and analysis of the memory card 109 file system table by the CPU 103 is directed by software executing on the CPU 103, the software can be developed to interface with essentially any type of memory card 109 file system.

The CPU 103 analyzes the file system table of the memory card 109 to identify a portion of available storage on the memory card 109 that can be used to receive the digital image data from the display memory 111. Often, the digital image data to be transferred will correspond to a complete image frame. However, the present invention can be used to transfer any amount of digital image data. Based on analysis of the memory card 109 file system table, the CPU 103 determines a starting address on the memory card 109 where the digital image data storage is to begin. Also, based on analysis of the memory card 109 file system table, the CPU 103 determines an amount of the digital image data that can be stored from the starting address forward without interfering with data already present on the memory card 109. In one embodiment, the memory card 109 state is such that a single, continuous portion of storage is available on the memory card 109 to receive an entirety of the digital image data to be transferred. However, in another embodiment, the memory card 109 state may require that a number of non-contiguous locations on the memory card 109 be used to store the entirety of the digital image data. In this embodiment, a number of transmissions between the graphics controller 101 and the memory card 109 are required to store the entirety of the digital image data, wherein the number of transmissions corresponds to the required number of non-contiguous locations on the memory card 109.

In accordance with the foregoing, the CPU 103 and file system table of the memory card 109 represent means for determining a location on the external storage to which the digital image data can be written. The CPU 103 also represents means for reading a file system table of an external storage and means for analyzing the file system table of the external storage to determine a location on the external storage to which the digital image data can be written.

The CPU 103 operates to program registers 117 with values indicating the starting address on the memory card 109 to which digital image data is to be written and the amount of the digital image data to be written. The CPU also operates to program registers 117 with a value indicating an address in the display memory 111 at which the digital image data to be transferred begins. The memory card interface 119 is configured to access and read the aforementioned values stored in registers 117. Thus, the memory card interface 119 is aware of the location in the display memory 111 from which digital image data is to be read, where the read digital image data is to be stored on the memory card 109, and how much digital image data is to be read and stored. The memory card interface 119 can also operate to program the memory card 109 with the information indicating where the digital image data is to be stored on the memory card 109. It should be appreciated that various memory cards can have different programming requirements regarding the location from which data is to be transmitted to the memory card, how much data is to be transmitted to the memory card, and at what location the transmitted data is to be stored on the memory card. It should be further appreciated that the memory card interface 119 of the present invention can be configured to program the memory card 109 according to its particular programming requirements.

In accordance with the foregoing, the CPU 103 and registers 117 represent means for specifying an address in the memory of the graphics controller at which the digital image data reading is to begin. The CPU 103 and registers 117 also represent means for specifying an address in the external storage to which the digital image data is to be written. Additionally, the CPU 103 and registers 117 represent means for specifying an amount of digital image data that is to be read from the memory of the graphics controller and written to the external storage.

Once the registers 117 are appropriately programmed as described above, the CPU 103 performs a final operation to provide a data transfer initiation signal (“go signal”). In one embodiment, the go signal can be provided by setting a value in a particular one of the registers 117. In this embodiment, the memory card interface 119 is configured to continuously monitor the particular register used to provide the go signal. In another embodiment, the go signal can be transmitted directly from the CPU 103 to the memory card interface 119. Upon receipt of the go signal, the memory card interface 119 begins the digital image data transfer from the display memory 111 to the memory card 109, in accordance with the parameters programmed in the registers 117.

Upon receiving the go signal, the image data wrapper module 121 will read the appropriate digital image data from the display memory 111, as indicated by arrow 133. The image data wrapper module 121 operates to format the digital image data in a manner that is compliant with the specific memory card 109 to which the digital image data is to be written. In one exemplary embodiment, the image data wrapper module 121 wraps the digital image data. Wrapping of the digital image data includes placing the digital image data in an appropriate transmission format, including generation of necessary control information to be included with the digital image data in the transmission. For example, in the case where the memory card 109 is a Secure Digital Card, the wrapping data includes identification of a start byte and end byte as part of the control information. It should be appreciated that the image data wrapper module 121 can be configured to wrap the digital image data in accordance with essentially any data transmission protocol. An important function performed by the image data wrapper module 121 during the wrapping process is to generate cyclic redundancy check (CRC) data for the digital image data. The generated CRC data is appended to the digital image data to be used by the memory card 109 to verify the integrity of the received digital image data.

Once the digital image data is appropriately wrapped by the image data wrapper module 121, the wrapped digital image data is transmitted to the memory card 109 via the memory card interface 119, as indicated by arrows 140 and 139. Reading, wrapping, and transmission of the digital image data from the display memory 111 to the memory card 109 continues until the programmed amount of digital image data, as represented in the registers 117, has been transmitted. Thus, the image data wrapper module 121 and the memory card interface 119 represent means for transmitting the digital image data from the graphics controller to the external storage, wherein the transmitting is performed without assistive processing by the CPU.

In accordance with the foregoing, the image data wrapper module 121 represents means for reading the digital image data from the memory of the graphics controller, wherein the reading is performed without assistive processing by the CPU. The image data wrapper module 121 also represents means for packaging the digital image data with transmission protocol formatting for transmission from the graphics controller to the external storage, wherein the packaging is performed without assistive processing by the CPU. The image data wrapper module 121 further represents means for generating a transmission packet in accordance with a transmission protocol, wherein the transmission packet includes the digital image data as a payload portion. The transmission packet further includes control information relevant to transmitting the transmission packet from the graphics controller to the external storage. Additionally, the image data wrapper module 121 represents means for generating the CRC data to be included with the digital image data when transmitted from the graphics controller to the external storage, wherein the CRC data is generated without assistive processing by the CPU.

In one embodiment, the memory card interface 119 includes a counter 142 to keep track of the number of bytes of digital image data that have been transmitted to the memory card 109. The memory card interface 119 is capable of checking the counter 142 value against the amount of digital image data to be transmitted as maintained in the registers 117. When the counter 142 value is equal to the amount of digital image data to be transmitted, the transmission is complete. In one embodiment, the memory card interface 119 is configured to send an interrupt signal to the CPU 103, via the host interface 115, upon completion of the digital image data transfer, as indicated by arrows 138 and 129. In accordance with the foregoing, the counter 142 represents means for tracking an amount of digital image data transmitted from the graphics controller to the external storage. The memory card interface 119 represents means for signaling the CPU when a desired amount of digital image data has been transmitted from the graphics controller to the external storage.

Each time the digital image data is transmitted to the memory card 109, the memory card 109 is operated to update its file system table. Therefore, upon completion of the digital image data transmission, the file system table of the memory card 109 is updated to reflect the digital image data written to the memory card 109. In one embodiment, if digital image data remains to be transmitted, the CPU 103 operates to perform another transmission of digital image data by reading the memory card 109 file system table from the memory card 109. Then, the sequence of operations as described above is repeated. In an alternate embodiment, if digital image data remains to be transmitted, the CPU 103 operates to analyze the memory card 109 file system table with consideration for the data previously transmitted to the memory card 109, in order to determine an appropriate memory card 109 location to which subsequent data can be transmitted. Then, the above-described sequence of operations is repeated.

It should be appreciated that the CPU 103 involvement in the digital image data transmission process from the graphics controller 101 to the memory card 109 is limited to initializing the memory card 109, reading and analyzing the file system table of the memory card 109, and appropriately programming the registers 117. Programming of the registers 117 includes specifying a display memory address from which digital image data is to be read, specifying a memory card 109 address to which digital image data is to be written, and specifying how much digital image data is to be transmitted. Once the CPU 103 has completed its responsibilities and issues the go signal, the CPU 103 is free to perform other tasks unrelated to the digital image data transmission.

An important feature of the present invention is that the CPU 103 does not have to read the digital image data from the display memory 111, generate corresponding CRC data, and write the digital image data and corresponding CRC data to the memory card 109. It should be appreciated that conventional graphic controllers do require the CPU to read and write all of the digital image data during transmission of the digital image data to a recipient device external to the graphics controller. Therefore, the graphics controller of the present invention serves to increase an amount of CPU bandwidth available for performing other tasks. Also, since the digital image data does not have to be transmitted over I/O lines between the graphics controller and the CPU, power that would have been required to toggle the I/O lines to facilitate transmission of the digital image data is saved.

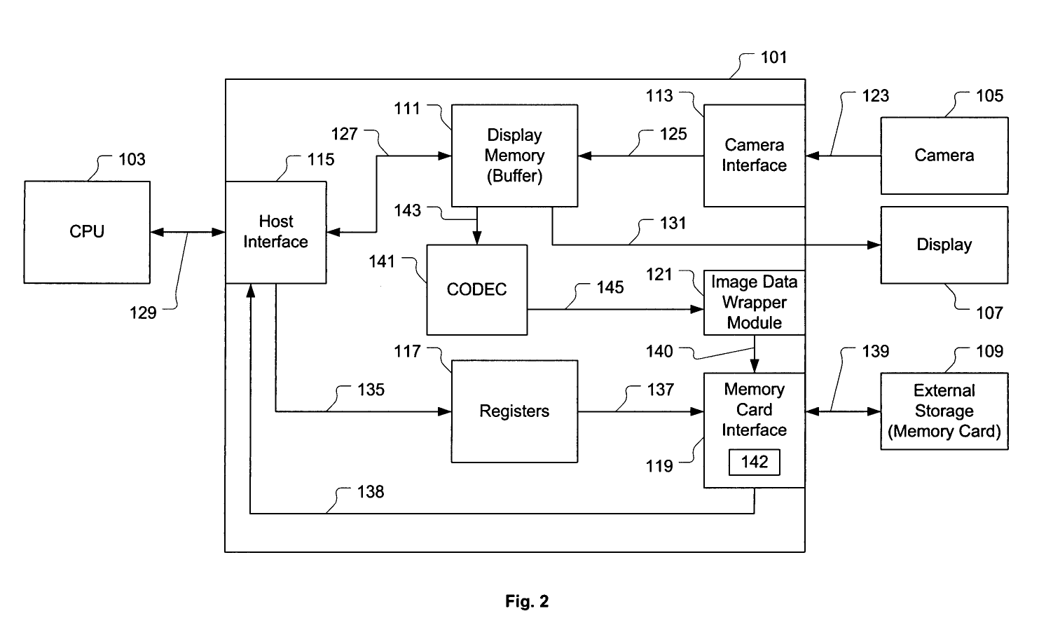

FIG. 2 is an illustration showing the digital image processing system of FIG. 1 including an encoder/decoder (CODEC) 141 for encoding and decoding the digital image data, in accordance with one embodiment of the present invention. Beyond the CODEC 141 and associated connections 143 and 145, the remainder of the digital image processing system of FIG. 2 is equivalent to that described with respect to FIG. 1. The CODEC 141 is disposed between the display memory 111 and the image data wrapper module 121. Thus, digital image data read from the display memory 111 passes through the CODEC 141 en route to the image data wrapper module 121, as indicated by arrows 143 and 145. When the memory card interface 119 directs the digital image data to be read from the display memory 111, the digital image data arriving at the image data wrapper module 121 will be encoded. Also, since the CODEC 141 is not disposed between the display memory 111 and the display 107, the display memory 111 is able to supply the display 107 with unencoded data. In one embodiment, the CODEC 141 is configured to perform JPEG encoding and decoding. In other embodiments, the CODEC 141 can be configured to perform other types of encoding and decoding.

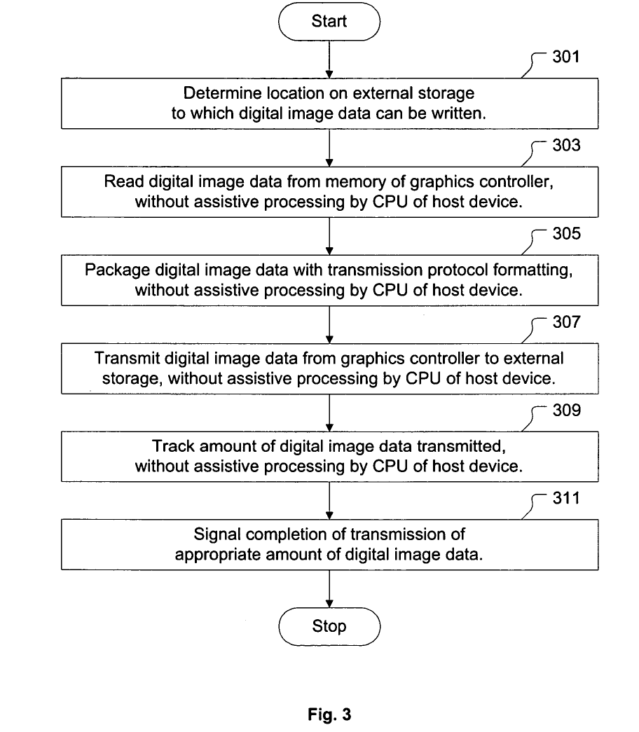

FIG. 3 is an illustration showing a flowchart of a method for transmitting digital image data from a graphics controller to an external storage, in accordance with one embodiment of the present invention. The method includes an operation 301 for determining a location on the external storage to which the digital image data can be written. In one embodiment, a file system table of the external storage is read and analyzed to determine the location on the external storage to which the digital image data can be written. Following determination of the location on the external storage to which the digital image data can be written, an address corresponding to the location in the external storage can be specified. Also, an amount of digital image data to be written to the external storage can be specified. The method can further include specifying an address within a memory of the graphics controller from which reading of the digital image data is to commence.

The method continues with an operation 303 in which the digital image data is read from the memory of the graphics controller. It should be appreciated that reading of the digital image data in the operation 303 is performed without assistive processing by a central processing unit (CPU) of a host device that is external to the graphics controller. In an operation 305, the digital image data is packaged with transmission protocol formatting in preparation for transmission from the graphics controller to the external storage. It should be appreciated that packaging of the digital image data in the operation 305 is also performed without assistive processing by the CPU of the host device that is external to the graphics controller. In one embodiment, packaging of the digital image data includes generating a transmission packet in accordance with a transmission protocol, wherein the transmission packet includes the digital image data as a payload portion. The transmission packet further includes control information relevant to transmitting the transmission packet from the graphics controller to the external storage. Additionally, packaging the digital image data in the operation 305 can also include generating cyclic redundancy check (CRC) data. The generated CRC data is included with the digital image data in the transmission packet. It should be appreciated that the CRC data generation is performed without assistive processing by the CPU of the host device that is external to the graphics controller.

In an operation 307, the digital image data is transmitted from the graphics controller to the external storage. Again, the transmitting of operation 307 is performed without assistive processing by the CPU of the host device that is external to the graphics controller. An operation 309 is provided for tracking an amount of digital image data transmitted from the graphics controller to the external storage. In one embodiment, the tracking can be performed by counting a number of bytes of digital image data transmitted from the graphics controller to the external storage. An operation 311 is also provided for signaling the CPU of the host device external to the graphics controller when a desired amount of digital image data has been transmitted from the graphics controller to the external storage.

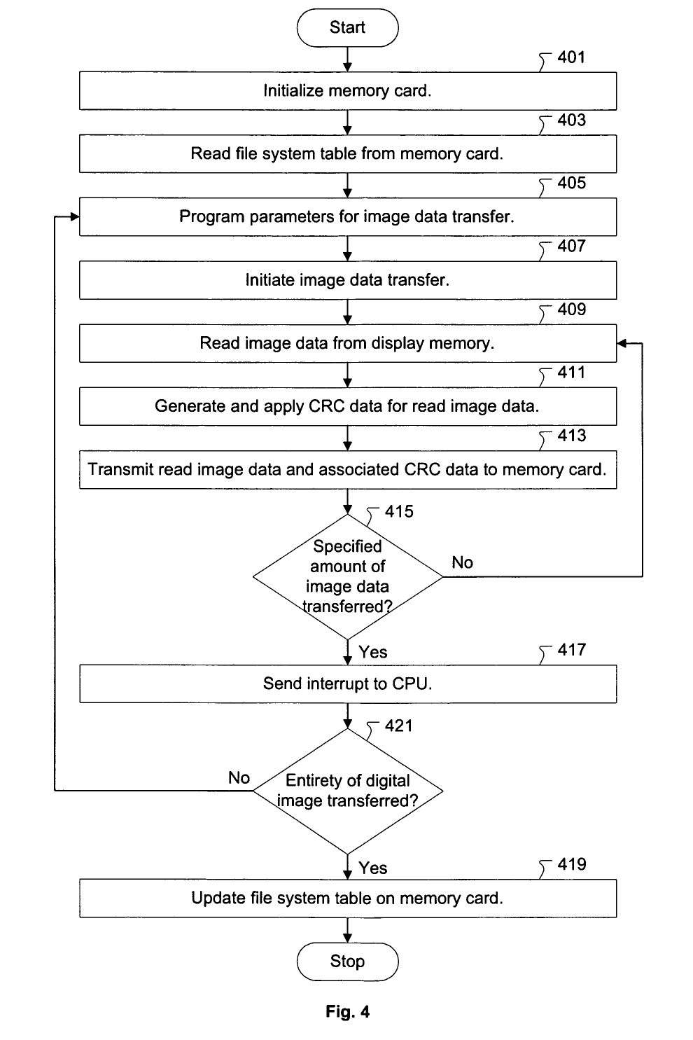

FIG. 4 is an illustration showing a flowchart of a method for transmitting data for an entire digital image from a graphics controller to a memory card, in accordance with one embodiment of the present invention. In an operation 401, the memory card is initialized to communicate with the graphics controller. An operation 403 follows in which a file system table of the memory card is read from the memory card. In one embodiment, the file system table of the memory card is read, via the graphics controller, by a central processing unit (CPU) of a host device to which the graphics controller is connected. In an operation 405, parameters for transferring image data from the graphics controller to the memory card are programmed into registers disposed within the graphics controller. The parameters can include an address within a display memory of the graphics controller from which image data reading should commence. The parameters can also include an address within the memory card to which the digital image data is to be written. Additionally, the parameters can include an amount of digital image data to be read from the graphics controller memory and written to the memory card. A number of the parameters programmed in the operation 405 can be determined through analysis of the file system table read from the memory card in the operation 403.

Once the appropriate parameters are programmed in the operation 405, the method continues with an operation 407 for initiating transmission of digital image data from the graphics controller to the memory card. In one embodiment, the CPU of the host device, to which the graphics controller is connected, initiates the transmission in the operation 407. However, further participation by the CPU of the host device is not required to complete the transmission of digital image data from the graphics controller to the memory card.

In an operation 409, image data is read from the display memory of the graphics controller. In one embodiment, reading of the image data in the operation 409 is performed by an image data wrapper module of the graphics controller. Reading of the image data in the operation 409 is performed without assistive processing by the CPU of the host device. Following operation 409, an operation 411 is performed to generate and apply cyclic redundancy check (CRC) data for the image data having been read from the display memory of the graphics controller. In one embodiment, generation and application of the CRC data in the operation 411 is performed by the image data wrapper module of the graphics controller without assistive processing by the CPU of the host device. Following generation and application of the CRC data in the operation 411, an operation 413 is performed to transmit the digital image data and associated CRC data to the memory card. In one embodiment, the transmission of operation 413 is directed by the image data wrapper module and is enable by a memory card interface.

The method continues with an operation 415 in which an inquiry is made to determine whether a specified amount of digital image data has been transferred from the graphics controller to the memory card. In one embodiment, a counter is used to track the amount of digital image data that has been transferred from the graphics controller to the memory card. The specified amount of digital image data to be transferred is defined by a parameter previously programmed in the operation 405. If the specified amount of digital image data has not been transferred to the memory card, the method reverts back to repeat operations 409 through 415, as previously described. If the specified amount of digital image data has been transferred to the memory card, the method continues with an operation 417 in which an interrupt is sent to the CPU of the host device. The interrupt notifies the CPU of the host device that the image data transmission as programmed in the operation 405 has been completed.

The method continues with an operation 421 in which an inquiry is made as to whether an entirety of the digital image has been transmitted from the graphics controller to the memory card. In some cases, a state of the memory card may require the data defining the digital image to be stored in a number of non-contiguous locations on the memory card. In these cases, the method operations 405 through 419 are performed to transfer digital image data to each of the non-contiguous locations. Therefore, a “no” response to the inquiry of operation 421 indicates both that the digital image is being stored in a number of non-contiguous location on the memory card and that some portion of the digital image remains to be transferred to the memory card. If the response to the inquiry of operation 421 is “no”, the method reverts back repeat operations 405 through 421, as previously described. However, if the response to the inquiry of operation 421 is “yes”, the entire digital image has been transmitted from the graphics controller to the memory card and the method continues with an operation 419.

In the operation 419, the file system table on the memory card is updated to reflect the image data transferred to the memory card. It should be appreciated that the memory card can be configured to automatically update the file system table as data is written to the memory card. Therefore, the method operation 419 can be performed at a number of possible instances relative to the other method operations previously described. Following operation 419, the method concludes.

Though the digital image processing systems of FIGS. 1 and 2 have been described primarily in terms of transmitting digital image data from the graphics controller to the memory card, i.e., external storage device, it should be appreciated that the digital image processing systems of FIGS. 1 and 2 also provide similar benefits when transmitting data in the reverse direction, i.e., from the external storage device to the graphics controller. More specifically, with respect to FIGS. 1 and 2, the CPU 103 can operate to read and analyze the file system table of the memory card 109, thus allowing a user to select data to be transmitted from the memory card 109 to the display memory 111 in the graphics controller 101. The CPU 103 can then be operated to program the registers 117 with information indicating the address on the memory card 109 from which data is to be read, the amount of data to be read, and the address in the display memory 111 from which writing of the data is to commence. Once the registers 117 are appropriately programmed, the CPU 103 issues a “go signal” to initiate the data transmission from the memory card 109 to the display memory 111. Following issuance of the “go signal”, further CPU 103 involvement is not required to complete the data transmission from the memory card 109 to the display memory 111.

The image data wrapper module 121 is configured to read the appropriate data from the memory card 109, via the memory card interface 119. The image data wrapper module 121 is also configured to perform CRC data checking to verify the integrity of the data received from the memory card 109. After the CRC data is verified, the image data wrapper module 121 writes the received data to the appropriate location in the display memory 111. The counter 142 of the memory card interface 119 can be used to track the amount of data successfully read from the memory card 109, to determine when the transmission is complete. Upon completion of the data transmission, an interrupt signal can be sent from the memory card interface 119 to the CPU 103 to inform the CPU 103 that the transmission has completed. It should be appreciated that the process for transmitting data from the memory card 109 to the display memory 111 of the graphics controller 101 can be conducted in a substantially reverse manner relative to the previously discussed process for transmitting data from the graphics controller 101 to the memory card 109. Therefore, it should be appreciated that the various interconnections between components within the digital image processing systems of FIGS. 1 and 2 are capable of transmitting data in either direction depending on the requirements of the particular data transmission being conducted.

As described above, the present invention provides an apparatus that is capable of transmitting digital image data between the graphics controller and an external storage device, e.g., memory card, with minimal involvement by the host CPU and without heavy I/O line toggling between the graphics controller and host CPU. Therefore, the present invention frees up the host CPU to perform other tasks and reduces power consumption during transmission of digital image data between the graphics controller and the external storage device.

The apparatus and method of the present invention can be particularly useful when implemented in portable electronic devices where processing power is at a premium. Some portable electronic devices that can benefit from the present invention include digital cameras, digital video recorders, digital camera or video enabled cell phones, and other handheld devices having digital imaging capability.

With the above embodiments in mind, it should be understood that the present invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations. Also, any of the operations described herein that form part of the invention can be performed by any suitable structural “means” that provide capability for performing the recited functionality. For instance, example structure is provided by way of the structural components described in the various embodiment of the claimed invention.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

1. A graphics controller comprising:
a memory for receiving image data from an image producing source;
an image data wrapper module including circuitry that operates independent of processing external to the graphics controller, the image data wrapper module configured to read image data from the memory and package the image data with transmission protocol formatting for transmission from the graphics controller to a memory card that is external to the graphics controller; and
a memory card interface configured to enable transmission from the graphics controller to the memory card of the image data having been packaged by the image data wrapper module.

2. A graphics controller as recited in claim 1, wherein the processing external to the graphics controller is provided by a central processing unit (CPU) of a host device to which the graphics controller is connected.

3. A graphics controller as recited in claim 1, wherein the image data wrapper module is further configured to generate cyclic redundancy check (CRC) data for the image data independent of processing external to the graphics controller.

4. A graphics controller as recited in claim 1, wherein the image data wrapper module is further configured to direct writing of the image data having been packaged by the image data wrapper module to the memory card without assistive processing by a central processing unit (CPU) of a host device that is external to the graphics controller.

5. A graphics controller as recited in claim 1, further comprising:
a first register for storing a value indicating an address in the memory from which image data is to be read by the image data wrapper module;
a second register for storing a value indicating an address on the memory card to which image data is to be written; and
a third register for storing a value indicating an amount of data to be transmitted from the graphics controller to the memory card.

6. A graphics controller as recited in claim 5, wherein the memory card interface is configured to access and read the values stored in the first, second, and third registers.

7. A graphics controller as recited in claim 1, wherein the memory card interface includes a counter to track an amount of digital image data transferred from the graphics controller to the memory card.

8. A method for transmitting digital image data from a graphics controller to an external storage, comprising:
determining a location on the external storage to which the digital image data can be written;
reading the digital image data from a memory of the graphics controller, wherein the reading is performed without assistive processing by a central processing unit (CPU) of a host device that is external to the graphics controller;
packaging the digital image data with transmission protocol formatting for transmission from the graphics controller to the external storage, wherein the packaging is performed without assistive processing by the CPU of the host device that is external to the graphics controller; and
transmitting the digital image data from the graphics controller to the external storage, wherein the transmitting is performed without assistive processing by the CPU of the host device that is external to the graphics controller.

9. A method for transmitting digital image data from a graphics controller to a memory card as recited in claim 8, further comprising:
reading a file system table of the external storage; and
analyzing the file system table of the external storage to determine a location on the external storage to which the digital image data can be written.

10. A method for transmitting digital image data from a graphics controller to a memory card as recited in claim 8, further comprising:
specifying an address in the memory of the graphics controller at which the digital image data reading is to begin;
specifying an address in the external storage to which the digital image data is to be written; and
specifying an amount of digital image data that is to be read from the memory of the graphics controller and written to the external storage.

11. A method for transmitting digital image data from a graphics controller to a memory card as recited in claim 8, wherein packaging the digital image data includes generating a transmission packet in accordance with a transmission protocol, the transmission packet including the digital image data as a payload portion, the transmission packet further including control information relevant to transmitting the transmission packet from the graphics controller to the external storage.

12. A method for transmitting digital image data from a graphics controller to a memory card as recited in claim 8, wherein packaging the digital image data includes generating cyclic redundancy check (CRC) data to be included with the digital image data when transmitted from the graphics controller to the external storage.

13. A method for transmitting digital image data from a graphics controller to a memory card as recited in claim 12, wherein generating the CRC data is performed without assistive processing by the CPU of the host device that is external to the graphics controller.

14. A method for transmitting digital image data from a graphics controller to a memory card as recited in claim 8, further comprising:
tracking an amount of digital image data transmitted from the graphics controller to the external storage.

15. A method for transmitting digital image data from a graphics controller to a memory card as recited in claim 14, further comprising:
signaling the CPU of the host device that is external to the graphics controller when a desired amount of digital image data has been transmitted from the graphics controller to the external storage.

16. An apparatus for transmitting digital image data from a graphics controller to an external storage, comprising:
means for determining a location on the external storage to which the digital image data can be written;
means for reading the digital image data from a memory of the graphics controller, wherein the reading is performed without assistive processing by a central processing unit (CPU) of a host device that is external to the graphics controller;
means for packaging the digital image data with transmission protocol formatting for transmission from the graphics controller to the external storage, wherein the packaging is performed without assistive processing by the CPU of the host device that is external to the graphics controller; and
means for transmitting the digital image data from the graphics controller to the external storage, wherein the transmitting is performed without assistive processing by the CPU of the host device that is external to the graphics controller.

17. An apparatus for transmitting digital image data from a graphics controller to an external storage as recited in claim 16, further comprising:
means for reading a file system table of the external storage; and
means for analyzing the file system table of the external storage to determine a location on the external storage to which the digital image data can be written.

18. An apparatus for transmitting digital image data from a graphics controller to an external storage as recited in claim 16, further comprising:
means for specifying an address in the memory of the graphics controller at which the digital image data reading is to begin;
means for specifying an address in the external storage to which the digital image data is to be written; and
means for specifying an amount of digital image data that is to be read from the memory of the graphics controller and written to the external storage.

19. An apparatus for transmitting digital image data from a graphics controller to an external storage as recited in claim 16, wherein the means for packaging the digital image data includes means for generating a transmission packet in accordance with a transmission protocol, the transmission packet including the digital image data as a payload portion, the transmission packet further including control information relevant to transmitting the transmission packet from the graphics controller to the external storage.

20. An apparatus for transmitting digital image data from a graphics controller to an external storage as recited in claim 16, wherein the means for packaging the digital image data includes means for generating cyclic redundancy check (CRC) data to be included with the digital image data when transmitted from the graphics controller to the external storage.

21. An apparatus for transmitting digital image data from a graphics controller to an external storage as recited in claim 20, wherein the means for generating the CRC data is operated without assistive operation by the CPU of the host device that is external to the graphics controller.

22. An apparatus for transmitting digital image data from a graphics controller to an external storage as recited in claim 16, further comprising:
means for tracking an amount of digital image data transmitted from the graphics controller to the external storage.

23. An apparatus for transmitting digital image data from a graphics controller to an external storage as recited in claim 22, further comprising:
means for signaling the CPU of the host device that is external to the graphics controller when a desired amount of digital image data has been transmitted from the graphics controller to the external storage.
